(19) United States
(12) Patent Application Publication
(10) Pub. No.: US 2013/0042018 A1
(43) Pub. Date: Feb. 14, 2013

(54) APPARATUS AND METHOD FOR PROVIDING STREAMING SERVICE

(71) Applicants: Je-Young MAENG, Suwon-si (KR); Jong-Hyo Lee, Pyeongtaek-si (KR)

(72) Inventors: Je-Young MAENG, Suwon-si (KR); Jong-Hyo Lee, Pyeongtaek-si (KR)

(73) Assignee: Samsung Electronics Co., Ltd., Suwon-si (KR)

(21) Appl. No.: 13/584,106

(22) Filed: Aug. 13, 2012

(30) Foreign Application Priority Data
Aug. 11, 2011 (KR) 10-2011-0080190

(51) Int. Cl. G06F 15/16

(52) U.S. Cl. 709/231

(57) ABSTRACT

A method and apparatus for providing a stable streaming service in transmitting data in a streaming form is provided. The method includes establishing a mutual connection between at least two mobile terminals; providing, by a first mobile terminal from among least two mobile terminals, reception sharing information corresponding to streaming data to at least one other mobile terminal from among the at least two mobile terminals; receiving, by the at least two mobile terminals, streaming data from a streaming server based on the reception sharing information; obtaining, by the first mobile terminal, streaming data received by the at least one other mobile terminal; and integrating, by the first mobile terminal, the streaming data from the streaming server and the obtained streaming data.

### PRIORITY

This application claims the priority under 35 U.S.C. §119(a) to an application filed in the Korean Intellectual Property Office on Aug. 11, 2011 and assigned Serial No. 10-2011-0080190, the entire contents of which are incorporated herein by reference.

### BACKGROUND OF THE INVENTION

1. Field of the Invention

The present invention relates generally to a streaming service, and more particularly to an apparatus and a method for providing a streaming service in a Universal Plug and Play (UPnP) based network.

2. Description of the Related Art

In general, a home network includes a private network based on an Internet Protocol (IP), which connects various types of devices used within a home to a common network through a common virtual computing environment called middleware, in order to control the devices. Examples of such devices include a Personal Computer (PC), an intelligent product, and a wireless device. Middleware enables communication between various devices by facilitating peer-to-peer connections between the devices. Up to now, Home Audio/Visual Interoperability (HAVI), Universal Plug and Play (UPNP), Java Intelligent Network Infra-structure (Jini), Home Wide Web (HWW), etc. are examples of middleware used for such connections.

A UPnP network defines a UPnP device, a UPnP service, and a protocol between the UPnP device and the UPnP service. Such a UPnP network includes a Controlled Device (CD) corresponding to a home network device controlled while being connected to the IP based home network, and a Control Point (CP) corresponding to a device for controlling the controlled device.

The CP performs a control for the CD, and corresponds to a component for making a request for an event and receiving the requested event. The CD performs a function determined according to the request of the CP. The CD corresponds to a component for transmitting the event to the CP that requested the event, when a state of the CD is changed.

As distribution of the mobile terminals expands and as it has become possible to stream contents existing in a remote server, a user can reproduce the contents in various places with various reproducing apparatuses.

FIG. 1 is a diagram illustrating a conventional process for providing a streaming service.

Referring to FIG. 1, when a user travels to the user's home, while using a streaming service existing on a network through a mobile terminal 130 located outside of the home, the user may desire to continuously use the streaming service within the home. Accordingly, the user can access the network by using a mobile communication network of the mobile terminal 130 (i.e., a base station or a Wireless Fidelity (Wi-Fi) Access Point (AP) 120), and access a service of a service provider 100 or access a streaming server 110 within the home. However, in streaming the contents, the transmission quality differs according to a state of the network.

As described above, when a mobile terminal accesses an IP network through a mobile communication network to receive a service, the mobile terminal generally is allocated a narrow bandwidth. When a plurality of mobile terminals accesses the same AP through Wi-Fi, the mobile terminals are also allocated a narrow bandwidth.

Therefore, the above-described allocations result a limitation in using a streaming service that requires a wide bandwidth. Further, when sufficient bandwidth is not available, transmission of an image may be broken or interrupted, and/or a service itself is terminated. Accordingly, there is a need for an environment where a service that requiring a high bandwidth capacity can be used, even when a sufficient network bandwidth cannot be supported due to an inability to access a broadband network (such as a Wi-Fi network, etc.), instability of the network, or excessive access by users.

### SUMMARY OF THE INVENTION

The present invention has been made to address at least the above problems and/or disadvantages and to provide at least the advantages described below. Accordingly, an aspect of the present invention provides an apparatus and a method for providing a stable streaming service in transmitting data in a streaming form. The present invention provides an apparatus and a method capable of optimally improving a service quality in providing a streaming service in a UPnP based network.

In accordance with an aspect of the present invention, a method of providing a streaming service in a Universal Plug and Play (UPnP) based network is provided. The method includes establishing a mutual connection between at least two mobile terminals; providing, by a first mobile terminal from among least two mobile terminals, reception sharing information corresponding to streaming data to at least one other mobile terminal from among the at least two mobile terminals; receiving, by the at least two mobile terminals, streaming data from a streaming server based on the reception sharing information; obtaining, by the first mobile terminal, streaming data received by the at least one other mobile terminal; and integrating, by the first mobile terminal, the streaming data from the streaming server and the obtained streaming data.

In accordance with another aspect of the present invention, an apparatus for providing a streaming service in a UPnP based network is provided. The apparatus includes a network connector for establishing a mutual connection between at least two mobile terminals; a control point for monitoring a network state to set reception sharing information corresponding to streaming data; a streaming controller for providing the reception sharing information corresponding to the streaming data to another mobile terminal from among the at least two mobile terminals, requesting the streaming data from a streaming server according to the reception sharing information, receiving streaming data corresponding to the requested streaming data from the server, and obtaining streaming data corresponding to the requested streaming data from the another mobile terminal; and a streaming data exchanger for integrating the streaming data received from the streaming server and the streaming data obtained from the another mobile terminal into integrated streaming data.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a conventional process for providing a streaming service;

FIG. 2 is a diagram illustrating a process for providing a streaming service according to an embodiment of the present invention;

FIG. 3 is a block diagram illustrating a mobile terminal for performing a streaming service according to an embodiment of the present invention; and

FIG. 4 is a signal flowchart illustrating communications between mobile terminals for providing a streaming service according to an embodiment of the present invention.

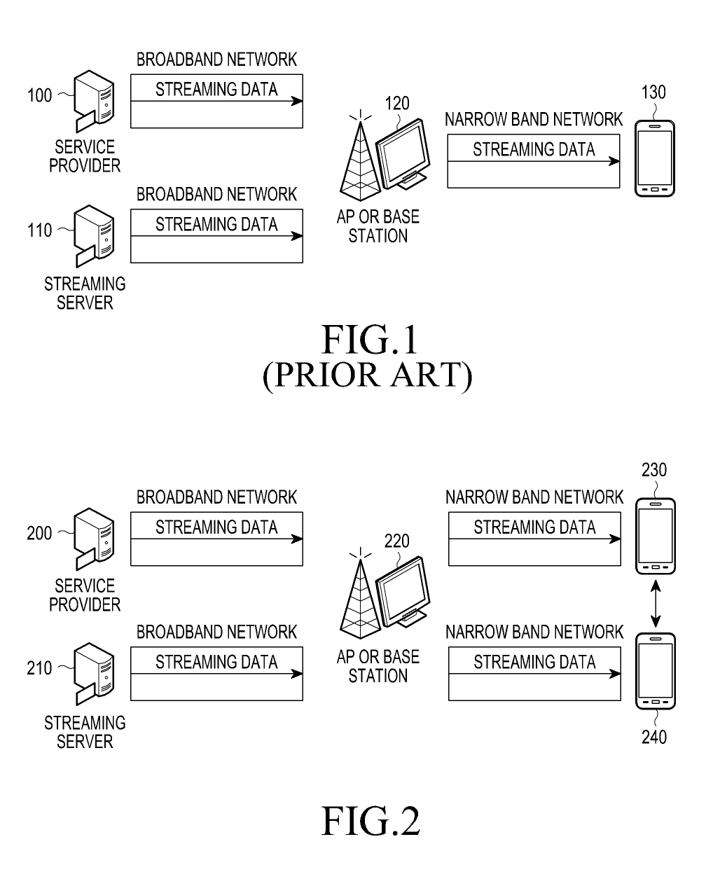

### DETAILED DESCRIPTION OF EMBODIMENTS OF THE PRESENT INVENTION

Hereinafter, embodiments of the present invention are described with reference to the accompanying drawings. In the following description, detailed explanations of components are merely provided only to help provide a general understanding of embodiments of the present invention, and various changes and modifications may be made therein without departing from the spirit and scope of the invention as defined by the appended claims. Further, in the following description, detailed descriptions of known functions and configurations incorporated herein may be omitted when such a description may make obscure the subject matter of the present invention.

In the following detailed description, although names of entities defined according to UPnP standards are used for convenience of description, the standards and names used herein do not limit the scope of the present invention, and the present invention is applicable to other systems having a similar technical background.

According to an embodiment of the present invention, a method of providing a stable streaming service in transmitting data through a streaming form is provided. In this method, after two or more mobile terminals are connected to each other in a UPnP based network, one mobile terminal provides another mobile terminal with control information on the streaming service, two or more of the mobile terminals are used to independently request the streaming and receive partial streaming data based on the control information, one mobile terminal integrates its own streaming data and streaming data received via the another mobile terminal, and the integrated streaming data is output. Through the processes, the user can use the streaming service requiring a broadband network even though the user has the mobile terminal supporting a narrow bandwidth.

A configuration of a system for providing a streaming service according to an embodiment of the present invention as described above is described as follows with reference to FIG. 2.

FIG. 2 is a diagram illustrating a process for providing a streaming service according to an embodiment of the present invention.

Referring to FIG. 2, a system according to an embodiment of the present invention includes a first mobile terminal 230 that receives contents from a service provider 200 through a base station 220 of a mobile communication network or receives the contents from a streaming server 210 through an access point 220 within the home. When contents are streamed, the first mobile terminal 230 additionally obtains streaming data through another mobile terminal as well as streaming data received from the service provider 200 or the streaming server 210, in order for the first mobile terminal 210 to provide an image according to a stable streaming service to the user. To this end, the system further includes a second mobile terminal 240 for providing streaming data required by the first mobile terminal 230. Although only two mobile terminals 230 and 240 are illustrated in FIG. 2, embodiments of the present invention are also applicable to cases where three or more mobile terminals are used.

The first mobile terminal 230 and the second mobile terminal 240 have a UPnP function therein according to embodiments of the present invention. The first mobile terminal 230 finds the second mobile terminal 240 through a Discovery process by using such a UPnP function. Then, the first mobile terminal 230 recognizes that there is a service by which network resources of the first mobile terminal 230 can be shared, and sets a connection. The first mobile terminal 230 performs the recognition through processes such as Description, Control, etc. In general, the Discovery, Description, and Control processes correspond to an operation process corresponding to communication stages in a UPnP network, and accordingly, detailed descriptions of these processes are omitted for clarity and conciseness.

The first mobile terminal 230 and the second mobile terminal 240 independently request the streaming service, and start to receive streaming data. At this time, when the user desires to receive the streaming service with the best quality, before receiving the streaming data, the first mobile terminal 230 sets information to dividedly receive the streaming data with the second mobile terminal 240.

For example, the first mobile terminal 230 sets an interval in consideration of a data transmission rate between mobile terminals, and in consideration of a speed at which the streaming data is received through the network. The first mobile terminal 230 provides the second mobile terminal 240 with information corresponding to the set interval so as to partially receive the streaming data according to an interval period. For example, when the interval is set to one second, during a four-second time period including four time points separated by one-second intervals, the first mobile terminal 230 may receives an image between first and second time points and another image between the third and fourth time points, while the second mobile terminal 240 receives an image between the second and third time points.

When each of the first mobile terminal 230 and the second mobile terminal 240 starts to receive the streaming data based on the information corresponding to the interval, the first mobile terminal 230 integrates the streaming data received by the first mobile terminal 230 and the streaming data received by the second mobile terminal 240, and reproduces content according to the integrated streaming data. When the contents correspond to images, seamless images may be output. More specifically, the first mobile terminal 230 integrates the streaming data directly received from the service provider 200 or the streaming server 210 and the streaming data received via the second mobile terminal 240. Accordingly, even when there is not sufficient bandwidth to use a streaming service requiring a wide bandwidth according to conventional methods, the user can still smoothly receive the service.

A setting operation for obtaining the streaming data may be achieved under a control of a control point. The control point is a logical software module for performing a control by using a UPnP action. The control point may be included in the first mobile terminal 230 for integrating the streaming data according to embodiments of the present invention. According to certain embodiments of the present invention, the control point may be defined as a Resource Sharing Device (RSD) control point.

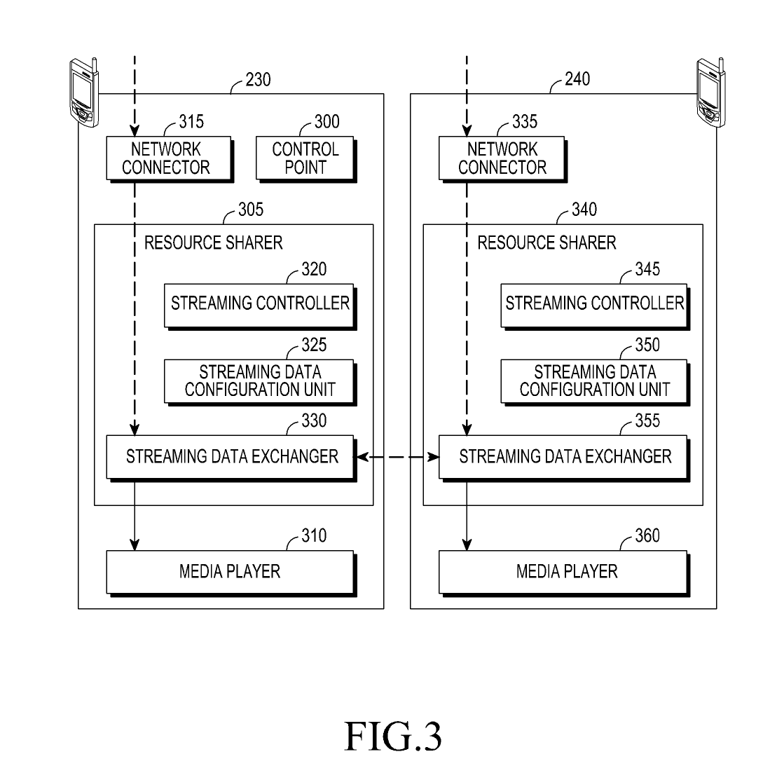

Hereinafter, components of the first mobile terminal 230 and the second mobile terminal 240 as described above, and operations of the components will described with reference to FIG. 3.

FIG. 3 is a block diagram illustrating a mobile terminal for performing a streaming service according to an embodiment of the present invention

Referring to FIG. 3, the first mobile terminal 230 includes a network adaptor 315, a resource sharing device 305, and a media player 310. Similarly, the second mobile terminal 240 includes a network adaptor 335, a resource sharing device 340, and a media player 360. The first mobile terminal 230, which is involved in obtaining streaming data, further includes a control point 300. Although only the first mobile terminal 230 in FIG. 3 includes a control point, other mobile terminals, such as the second mobile terminal 240, may include a control point, in accordance with embodiments of the present invention. When all of the mobile terminals include respective control points, the mobile terminals can find each other. In this case, at least one of the mobile terminals should be designated to integrate or reproduce the streaming data. Accordingly, when at least one mobile terminal includes a control point, it is possible to integrate and reproduce the streaming data, and thus it is possible to receive a stable streaming service. Accordingly, the user can consume the content by using the mobile terminal.

As shown in FIG. 3, the first mobile terminal 230 and the second mobile terminal 240 have some components in common, and these common components operate in a similar manner within each of the respective mobile terminals. Accordingly, descriptions of operations of the components included in the first mobile terminal 230 may also be applied to corresponding components of the second mobile terminal 240.

A streaming controller (or alternatively, a streaming control module) 320 requests streaming data from the service provider 200 or the streaming server 210. Further, the streaming controller 320 also provides streaming data reception sharing information to another mobile terminal. According to embodiments of the present invention, the first mobile terminal 230 and the second mobile terminal 240 requests to partially receive streaming data alternately according to a predetermined period. In response to the requests, a beginning point and an ending point of the streaming data are designated and partial streaming data is requested.

The streaming data configuration unit (or alternatively, a streaming controller configuration module) 325 receives a parameter such as an interval gap (or other similar parameter) according to a current Wide Area Network (WAN) network state from the control point 300. A streaming data request time of the streaming controller 320 is controlled based on the parameter.

The control point 300 controls a resource sharer 340 and sets the interval for a method of receiving the partial streaming data according to the current network state. The control point 300 can monitor such a network state by subscribing to an event provided by the service.

A streaming data exchanger 330 receives partial streaming data from the second mobile terminal 240, or transmits streaming data received through a network connector 315. The network connector 345 performs a mutual connection with the second mobile terminal 240, or connects to the server that provides the streaming data. The streaming data exchanger 330 integrates the streaming data directly received through the network connector 315 and the streaming data from the second mobile terminal 240 in order to generate a single integrated streaming data file.

A media player 310 reproduces the integrated streaming file.

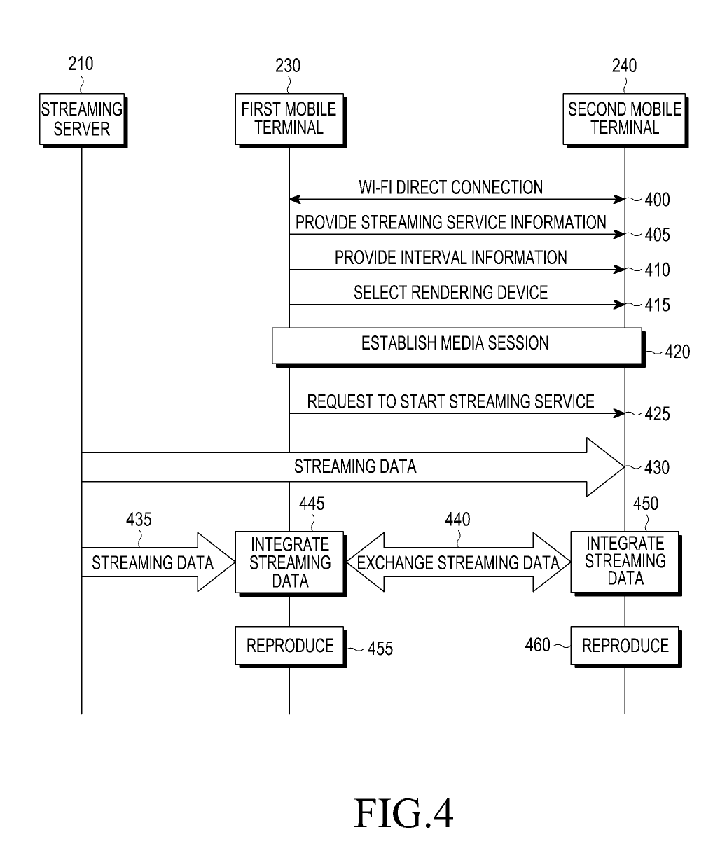

A process in which the first mobile terminal 230 of FIG. 3 receives a streaming service by using one mobile terminal is described as follows with reference to FIG. 4. FIG. 4 illustrates a process in which two or more mobile terminals find each other, set a session, and then exchange partially received streaming data through the set session.

FIG. 4 is a signal flowchart illustrating communications between mobile terminals for providing a streaming service according to an embodiment of the present invention.

Referring to FIG. 4, the first mobile terminal 230 and the second mobile terminal 240 establish a Wi-Fi Direct connection between each other in step 400. The Wi-Fi direct connection is a mutual Wi-Fi connection without an AP, and corresponds to an improved type of a conventional Wi-Fi ad-hoc mode. When there are three or more mobile terminals, the UPnP network can be configured through the operation process for each stage between devices of the general UPnP network, such as Discovery, Description, and Control processes. To this end, all of the mobile terminals may include the resource sharer, and in this case, the mobile terminals are able to find each other. At this time, when one or more mobile terminals include the control point, all the mobile terminals that include the control point can integrate streaming data to reproduce the integrated streaming data. As described above, the user can receive the streaming service by controlling another mobile terminal by using one mobile terminal including the control point.

Hereinafter, a process where the first mobile terminal 230 receives the streaming service and reproduces the received streaming service is described as an example.

When the first mobile terminal 230 acts as a subject for receiving the streaming service, the first mobile terminal 230 provides reception sharing information to another mobile terminal. Accordingly, the first mobile terminal 230 provides the second mobile terminal 240 with streaming service information in step 405. Here, the streaming service information contains, for example, an address of a server for providing streaming data such as an IP address of the service provider 200, or an IP address of the streaming server 210 within the home, a content name to be provided in a streaming form, etc. Subsequently, the first mobile terminal 230 provides the second mobile terminal 240 with interval information, in step 410. Here, the interval information refers to a period in which the second mobile terminal 240 partially receives the streaming data. Every streaming data received according to the interval period may include information for assigning IDentification (ID) information to the streaming data. The identification information is used to sequentially integrate the streaming data.

Further, when three or more mobile terminals receive the streaming data, the first mobile terminal 230 can set a priority and provide other mobile terminals with information corresponding to the priority together with information corresponding to the interval period. The information corresponding to the priority indicates priorities assigned to devices to receive the streaming data according to the interval period. A device having a higher priority receives the streaming data earlier than other devices. More specifically, order information is provided so that the mobile terminals sequentially receive the streaming data according to the interval period.

Such a process of setting the priority corresponds to a process of setting and providing the reception sharing information such that the mobile terminals receive divided streaming data. For example, the first mobile terminal 230 sets the interval by considering a data transmission rate between mobile terminals, and a speed at which the streaming data is received through the network, and provides the second mobile terminal 240 with information corresponding to the set interval so as to partially receive the streaming data according to the interval period.

Subsequently, the user determines a mobile terminal to reproduce streaming data after integrating the partially received streaming data. When the mobile terminal set to reproduce a streaming file generated by integrating the streaming data is determined, in step 415, a rendering device is selected from a provided rendering device list. For example, the first mobile terminal 230 can reproduce the streaming file alone, or the first mobile terminal 230 and the second mobile terminal 240 can reproduce the streaming file at the same time. When the two mobile terminals reproduce the streaming file at the same time, a process of exchanging the streaming data is required.

When such an information providing process is completed, a media session between the first mobile terminal 230 and the second mobile terminal 240 is established in step 420. When the media session is established, the first mobile terminal 230 transmits a request for the data streaming to the second mobile terminal 240 in step 425. The request for the streaming data includes identification information of desired partial streaming data to be obtained from the second mobile terminal 240. The first mobile terminal 230 and the second mobile terminal 240 start receiving the streaming data according to the request in steps 430 and 435, respectively. At this time, the first mobile terminal 230 and the second mobile terminal 240 alternately receive the streaming data according to their interval periods, priority information, etc. Accordingly, the first mobile terminal 230 assigns identification information such as ID=1, ID=3, ID=5 and the like to respective streaming data received according to the interval period, and the second mobile terminal 240 assigns identification information such as ID=2, ID=4, ID=6, etc.

When the rendering device list includes the first mobile terminal 230 and the second mobile terminal 240, the mobile terminals 230 and 240 exchange the streaming data, and integrate the streaming data in steps 445 and 450, respectively, and reproduce the integrated streaming file in steps 455 and 460, respectively. The streaming data is integrated as one streaming file based on the identification information.

According to embodiments of the present invention, even when a mobile terminal is provided with a narrow bandwidth, the user can use a streaming service requiring a broadband network through the use of two or more mobile terminals. Further, according to embodiments of the present invention, even when the user carries the mobile terminal to a place in which the broadband network is not supported, the user can consume content together with other members at the new location.

While the present invention has been shown and described with reference to certain embodiments thereof, it will be understood by those skilled in the art that various changes in form and detail may be made therein without departing from the spirit and scope of the invention as defined by the appended claims.

What is claimed is:

1. A method of providing a streaming service in a Universal Plug and Play (UPnP) based network, the method comprising:
establishing a mutual connection between at least two mobile terminals;
providing, by a first mobile terminal from among least two mobile terminals, reception sharing information corresponding to streaming data to at least one other mobile terminal from among the at least two mobile terminals;
obtaining, by the first mobile terminal, streaming data from the at least one other mobile terminal that receives the streaming data from a streaming server based on the reception sharing information; and
integrating, by the first mobile terminal, streaming data received from a streaming server and the streaming data obtained from the at least one other mobile terminal.

2. The method as claimed in claim 1, wherein providing the reception sharing information to the at least one other mobile terminal comprises providing, by the first mobile terminal, an address of the streaming server and a content name to the at least one other mobile terminal.

3. The method as claimed in claim 1, wherein providing the reception sharing information to the at least one other mobile terminal comprises providing an interval period in which the streaming data is received.

4. The method as claimed in claim 3, further comprising receiving a portion of the streaming data according to the interval period.

5. The method as claimed in claim 3, wherein, when the first mobile terminal provides the reception sharing information to at least two other mobile terminals, the reception sharing information includes priority information by which the at least two mobile terminals sequentially receive the streaming data according to the interval period.

6. The method as claimed in claim 1, further comprising reproducing the integrated streaming data.

7. The method as claimed in claim 1, wherein providing the reception sharing information to the at least one other mobile terminal comprises determining at least one mobile terminal to reproduce the integrated streaming data and providing a list of the determined at least one mobile terminal.

8. The method as claimed in claim 7, further comprising exchanging the streaming data between the first mobile terminal and the at least one other mobile terminal when the determined list of the mobile terminal includes all of the at least two mobile terminals.

9. An apparatus for providing a streaming service in a Universal Plug and Play (UPnP) based network, the apparatus comprising:
a network connector for establishing a mutual connection between at least two mobile terminals;
a control point for monitoring a network state to set reception sharing information corresponding to streaming data;
a streaming controller for providing the reception sharing information corresponding to the streaming data to another mobile terminal from among the at least two mobile terminals, requesting a portion of streaming data from a streaming server according to the reception sharing information, receiving the portion of streaming data from the server, and obtaining a remainder of the streaming data from the another mobile terminal; and
a streaming data exchanger for integrating the portion of streaming data received from the streaming server and the remainder of the streaming data obtained from the another mobile terminal into integrated streaming data.

10. The apparatus as claimed in claim 9, further comprising a media player for reproducing the integrated streaming data.

11. The apparatus as claimed in claim 9, wherein the reception sharing information includes an address of the streaming server and a content name.

12. The apparatus as claimed in claim 9, wherein the reception sharing information includes an interval period in which the streaming data is received.

13. The apparatus as claimed in claim 12, wherein the streaming controller receives the portion of the streaming data from the streaming server according to the interval period.

14. The apparatus as claimed in claim 12, wherein the reception sharing information includes priority information by which the mobile terminals sequentially receive the streaming data according to the interval period.

15. The apparatus as claimed in claim 9, wherein, when a list of mobile terminals to reproduce the integrated streaming data includes all of the at least two mobile terminals, the streaming data exchanger exchanges the streaming data received from the streaming server with the another mobile terminal.
